(19) United States
(12) Patent Application Publication
(10) Pub. No.: US 2007/0255769 A1
(43) Pub. Date: Nov. 1, 2007

(54) System of hierarchical policy definition, dissemination, and evaluation

(75) Inventors: Dakshi Agrawal, Monsey, NY (US); Allen Gilbert, Austin, TX (US); James Ryan Giles, Yorktown Heights, NY (US); David Louis Kaminsky, Chapel Hill, NC (US); Vaughn Theodore Rokosz, Newton, MA (US); Dinesh Chandra Verma, Mount Kisco, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/403,844

(22) Filed: Apr. 14, 2006

(51) Int. Cl. G06F 17/30

(52) U.S. Cl. 707/205

(57) ABSTRACT

A system for defining, disseminating, and evaluating policies in a policy-based decision system includes a unit for defining a hierarchy of policy groups, a unit for associating a group of orthogonal parameters with at least one policy group, a unit for defining at least one policy for one or more policy groups in said hierarchy, a unit for disseminating policies to one or more decision making component for at least one policy group in said hierarchy, and a unit for evaluating policies for at least one policy groups in the hierarchy.

### BACKGROUND OF THE INVENTION

1Field of the Invention

The present invention relates to the field of policy based decision systems, and more specifically to management of policies in such systems.

2. Description of the Related Art

Policies governing and managing organizations, business processes, computing systems etc. are often defined in an hierarchical structure due to the inherent hierarchical relationships of these subjects.

Manual administration of hierarchical policies to govern organizations is as old as civilization itself. However, manual administration is error-prone, requires skilled operators, and is not readily scalable.

The first automated administration of hierarchical policies appeared with the advent of computers, particularly in the area of access policies for file systems. The first generation of automated administration was specific to the application area in which the policies were applicable and could not be used outside the specific context to which these solutions were targeted.

The second generation of these automated administration systems is based on generic software that can be reused in multiple application areas. Examples of such inventions are knowledge bases and expert systems that can be populated with hierarchical policies and queried for policies that are applicable in a given context (see, for example, U.S. Pat. Nos. 5,826,250, 6,247,007, 6,105,063, 5,889,953, 5,838,918, and 5,797,128).

Conventional automated solutions to the administration of hierarchical policies have the following major drawbacks: 1) they emphasize efficient storage and retrieval of policies, rather than applicability in a distributed computing environment; 2) exploitation of a hierarchical structure of policies is decoupled among definition, dissemination, and evaluation, leading to tools that are ill-suited to define such policies; 3) an absence of an explicit prioritizing of policies leads to either a constraint of one policy for each hierarchy or an ambiguous evaluation result in case multiple policies correspond to the same hierarchy; 4) there is an inability to specify attributes that are orthogonal to the attributes determining policy hierarchy; and 5) the hierarchical structure of policies is tied too closely to the policy fragments resulting in an inflexible framework to define policies. As a result, the usefulness of the policy implementation is limited to the areas, which follow the constraints imposed by the hierarchical structure.

### SUMMARY OF THE INVENTION

In view of the foregoing and other exemplary problems, drawbacks, and disadvantages of the conventional methods and structures, an exemplary feature of the present invention is to provide an apparatus for defining, disseminating, and evaluating policies in a policy-based decision system includes means for defining a hierarchy of policy groups, means for associating a group of orthogonal parameters with a policy group, means for defining a policy for a policy group in the hierarchy, means for disseminating policies to a decision making component for the policy group in the hierarchy, and means for evaluating policies for a policy group in the hierarchy.

An exemplary embodiment of the present invention provides a system and method to coherently define, disseminate, and evaluate hierarchical policies.

An exemplary embodiment of the present invention may include:
1) A multiple inheritance data structure, referred to as the policy hierarchy graph, to define a hierarchy of policy groups,
2) Policies that each belong to a policy group,
3) A policy group that has a set of associate orthogonal parameters that describe input variables and/or actions that can be used in a policy definition,
4) Policies that have an optional priority that indicates perceived importance or precedence of a policy,
5) Policies that each have an applicability flag to describe the applicability of the policy to one of the following: a) a group to which the policy is associated, b) a group to which the policy is associated and their immediate children groups, c) a group to which the policy is associated and all of the descendants groups, and d) a group to which the policy is associated and all descendants within a specified number of generations of such groups.

While defining policies, a policy author may consult a policy hierarchy graph and assign a policy to a policy group. If a policy group has an orthogonal parameter, then this orthogonal parameter may be used to define policies. In addition to variable and action names, an orthogonal parameter may provide a rich description of how a computing device may obtain values for variables or how it should execute to evaluate policies. An author may also assign an optional priority to a policy and choose the value of an applicability flag. Policies, thus defined, may be stored in a federated storage to be disseminated further to policy-based decision making components.

Dissemination of policies may be governed by a publication-subscription system where a decision making component subscribes to a policy group. As a result of subscribing to a policy group, a decision making component may receive policies that correspond to the subscribed policy group and policies defined in ancestral policy groups that indicate an applicability flag, which encompasses the subscribed policy group.

To get policy guidance, a decision point may specify a policy group and (optionally) a path through a hierarchical structure of policy groups, as well as orthogonal parameters that may be used to define and evaluate policies within those groups. For the specified path and the policy group, an aggregate of policies may be evaluated. The final result of an evaluation may be a combination of results of all policies that have true preconditions. A combination module is application specific and may exploit the priority of policies.

An exemplary embodiment of the present invention integrates the hierarchical structure of policy groups in all stages of policy definition, dissemination, and evaluation.

An exemplary embodiment of the present invention introduces loose coupling among policy editor, policy repository, and decision makers and decision points without restricting the form and content of a policy. Thus, an exemplary embodiment of the present invention lends itself to generic policy implementation with broad applicability.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system 100 for hierarchical policy definition, dissemination, and evaluation in accordance with an exemplary embodiment of the present invention;

FIG. 2 is a flow diagram 200 illustrating policy definition, deployment, and evaluation according to hierarchical scope in accordance with an exemplary embodiment of the present invention; and

FIG. 3 illustrates exemplary relationships among policy groups and how policies may be selected based on scope in accordance with an exemplary embodiment of the present invention.

To facilitate understanding, identical reference numerals have been used, where possible, to designate identical elements that are common to the figures.

### DETAILED DESCRIPTION OF EXEMPLARY EMBODIMENTS OF THE INVENTION

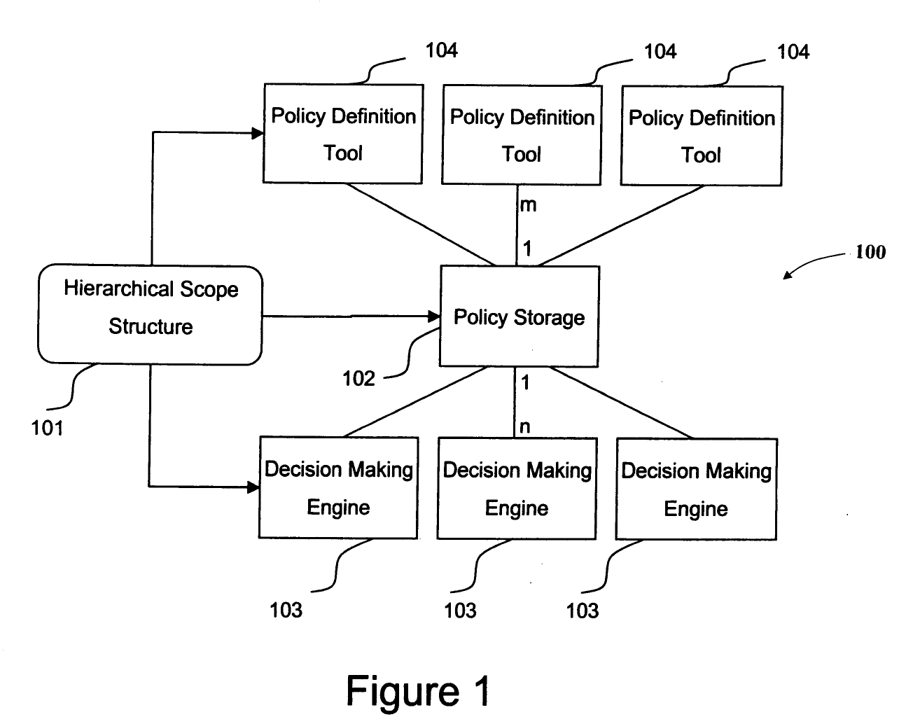

Referring now to the drawings, and more particularly to FIGS. 1-3, there are shown exemplary embodiments of the method and structures of the present invention.

A system 100 for hierarchical policy definition, dissemination, and evaluation in accordance with an exemplary embodiment of the present invention is shown in FIG. 1. To drive a policy system, a hierarchical scope structure 101 for policy groups may be developed by a domain expert.

In an exemplary embodiment, a declaration (not shown) indicates whether policy groups higher up in an hierarchy have priority over policy groups lower down in the hierarchy and vice-versa. In addition, a declaration may associate orthogonal parameters with policy groups. These orthogonal parameters may describe input variables for policies in a policy group that will be resolved at policy evaluation time, and they may describe action or action parameters for policies that are found to be applicable at policy evaluation time.

An hierarchical structure may be used to define policies for different policy groups. A definition tool (not shown) may exploit the hierarchical structure of policy groups to validate policies in the system, for example, to indicate if two policies are in conflict with each other, or if a defined policy is redundant, etc. The policies may be defined by multiple users without coordination among them and may be stored in a repository. Conflicts among multiple users are resolved using one of the standard techniques (check-out locks, write/modify/erase permissions etc).

In the exemplary embodiment of FIG. 1, the same hierarchical scope structure 101 is used by policy definition tools 104, a policy storage system 102, and a decision making engine 103. The policy definition tools 104 use the hierarchical scope structure 101 for an editing function and for policy storage. The decision making engines 103 use the hierarchical scope structure 101 to determine policy applicability.

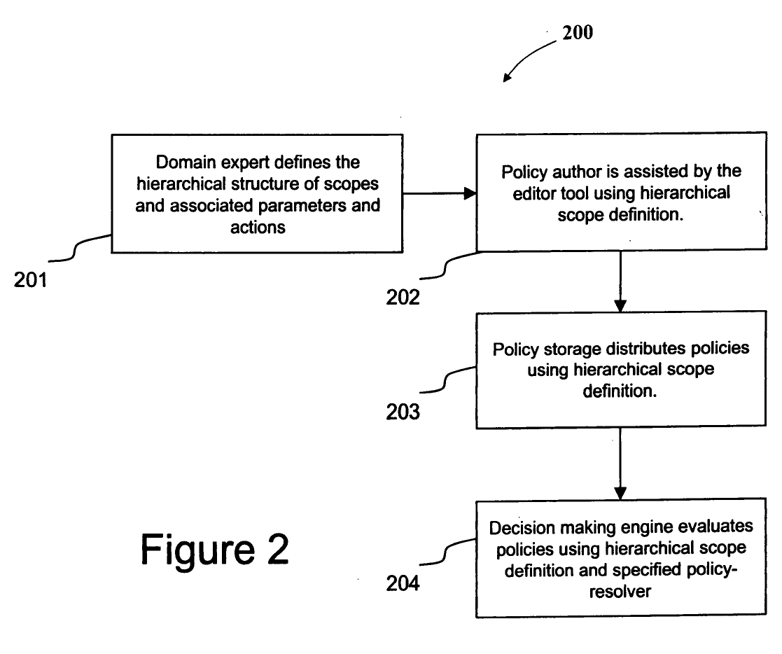

FIG. 2 illustrates an exemplary workflow 200 for a system 100 in accordance with an exemplary embodiment of the present invention. In step 201, a domain expert defines a hierarchical scope structure 101 and orthogonal parameters for all of the policy groups within the system. Then, in step 202, a policy author definition tool 104 defines policies according to the hierarchical scope structure 101. In step 203, the policies are stored in a policy storage system 102. In an exemplary embodiment, the policy storage system 102 is centralized, but optionally it may be distributed or replicated.

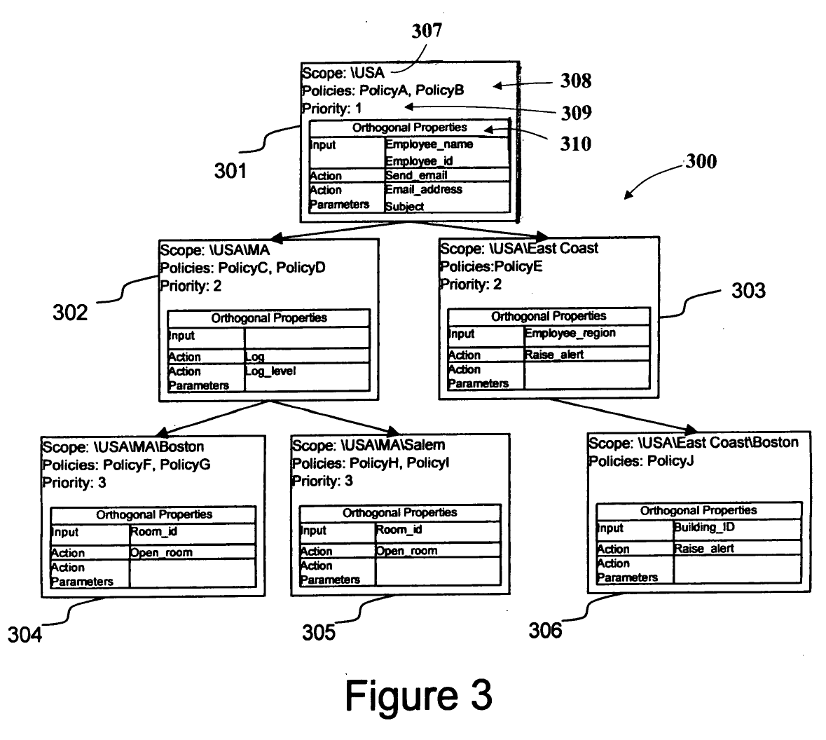

In step 204, a decision making engine 103 obtains all policies applicable for a particular hierarchical scope structure 101 from the policy storage system 102 after taking into consideration the hierarchical scope structure 101 of the policies. For example, in a hierarchical scope structure 101 that defines country nodes at high level of a hierarchy, followed by regions, followed by cities, if a decision making engine 103 asks for policies corresponding to a scope of \USA\MA\Boston, then the decision making engine 103 would receive policies that are applicable for scopes of \USA\MA\Boston 304, \USA\MA 302, and \USA 301 (referring to FIG. 3).

On the other hand if a decision making engine 103 asks for policies for a scope of \USA\*\Boston, the decision making engine 103 would receive policies for scopes of \USA\MA\Boston 304, \USA\East Coast\Boston 306, \USA\MA 02, \USA\East Coast 303, and \USA 301, given that Boston is a city defined in two regions in policy groups: MA 302 and East Coast 303. The decision making engine 103 may then evaluate the policy using the hierarchical scope definition rules.

In an exemplary embodiment of the present invention, a mechanism for distributing policies to decision making engines may be a publish-subscribe system where decision making engines 103 subscribe to policies of a particular scope.

FIG. 3 illustrates an exemplary embodiment of a hierarchical policy structure 300 in which hierarchical scopes are defined in terms of nation, region, and city. Other embodiments may have other types of hierarchies that may depend on an organization structure, a containment relationship, or any arbitrary parent/child relationship.

When a decision making engine 103 starts, it may request policies in a policy group from the policy storage 102. The policy storage 102 may send back all policies corresponding to the request, after taking the hierarchical scope structure 101 of the policies into account. The highest priority policy group in this embodiment (301) has a scope 307 of \USA, two policies 308 named PolicyA and PolicyB, a priority 309 of 1, and several orthogonal properties 310. In this case, a higher priority is given to larger priority numbers. The orthogonal properties 310 may include input variables “Employee_name” and “Employee_id”, action “Send_email”, and action parameters “Email_address” and “subject”.

In an exemplary embodiment, policies in a group may be defined in terms of orthogonal properties, with the value of the orthogonal properties determined at policy evaluation time. For example, PolicyA may be described in text as: “With Priority 5, if Employee_name=‘Bob’ or Employee_id=‘12345’ then Send_email to Email_address”.

To evaluate the policies 308 in policy group 301 having a scope 307 of \USA, a decision making engine 103 needs to obtain values or implementations for the orthogonal properties 310 Employee_name, Employee_id, and Email_address and Send_email.

In an exemplary embodiment, a decision making engine 103 may obtain all orthogonal properties 310.

In another exemplary embodiment, a decision making engine 103 may need only a set of orthogonal properties 310 that are actually used by a policy in a group.

FIG. 3 also illustrates two policy groups 302 and 303 defined at a regional level with scopes 307 of \USA\MA and \USA\East Coast, respectively, as well as three policy groups 304-306 defined at a city level with scopes 307 \USA\MA\Boston, \USA\MA\Salem, and \USA\East Coast\Boston, respectively. Each of these groups has its own defined orthogonal properties 310, but in an exemplary embodiment, each group may also inherit orthogonal properties 310 of higher priority policy groups.

For example, the policy group 304 has a scope 307 of \USA\MA\Boston, orthogonal properties 310 of Room_id, and Open_room, but may also inherit orthogonal properties 310 of Log and Log_level from policy group 302 having a scope 307 of \USA\MA and also from policy group 301 having orthogonal properties 310 of Employee_name, Employee_id, Send_email, Email_address, and Subject. Thus, a policy 308 written for a scope 307 of \USA\MA\Boston may incorporate any or all of the orthogonal properties 310 of Room_id, Open_room, Log, Log_level, Employee_name, Employee_id, Send_email, Email_address, and Subject.

In an exemplary embodiment of the present invention, if a decision making engine 103 subscribes to a scope 307 then it will have access to policies 308 from groups of all higher priorities 309. For example, if, in the preceding example, a decision making engine 103 subscribes to a policy group 304, policies 308 having a scope 307 of \USA\MA\Boston, and the hierarchical structure 300 indicates that deeper levels of policy groups have a higher priority, then all policies 308 corresponding to the policy group 304 having a scope 307 of \USA\\\A\Boston, would be evaluated first, followed by policies 308 within policy groups 302 and 301, which have scopes of \USA\MA, and \USA, respectively.

In an exemplary embodiment, all applicable policies 308 are sent to a policy-resolver (not shown) which provides a final decision applicable for a policy request based on rules for choosing among policies within different policy groups. Note that various optimizations based on hierarchies are possible. For example, if in an exemplary embodiment a policy-resolver always returns policies 308 with highest priority 309, then policies 308 within policy groups 302 and 303 having scopes of \USA\MA and \USA, respectively, may not be evaluated if one or more policies for \USA\MA\Boston evaluate to true.

On the other hand, if \USA scopes always need to be satisfied for \USA\MA\Boston, then a decision or portion of a decision indicated by policies for \USA\MA\Boston, may be superseded by a decision or portion of a decision indicated by a policy for \USA.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. An apparatus for defining, disseminating, and evaluating policies in a policy-based decision system, said apparatus comprising:
means for defining a hierarchy of policy groups;
means for associating a group of orthogonal parameters with at least one of said policy groups;
means for defining a policy for one of said policy groups;
means for disseminating said one policy group to a decision making component; and
means for evaluating said policy for said one of said policy groups.

2. The apparatus of claim 1, further comprising:
means for associating a group of orthogonal parameters with a policy group,
wherein said group of orthogonal parameters comprises:
input variables to be resolved at a policy evaluation time;
action descriptions for applicable polices at the policy evaluation time; and
action parameters to be resolved at the policy evaluation time, and
wherein said means for defining said policy comprises:
means for aggregating the orthogonal parameters associated with said policy group and one other policy group;
means for exposing said aggregated orthogonal parameters to a policy author, and where policy updates for a particular policy group include relevant policy updates in ancestral policy groups, and
means for resolving conflicts that give priorities to first the policies defined higher or lower in the policy group hierarchy; and
second the policies with higher assigned priority.

3. The apparatus of claim 1, wherein said means for defining a hierarchy of policy groups produces a multiple inheritance data structure to relate at least two policy groups in parent child relationships.

4. The apparatus of claim 1, wherein said means for disseminating policies includes a mechanism that allows a decision making component to register for policies in at least one policy group and receive policy updates relevant only to the registered policy groups, and
wherein said apparatus further comprises means for resolving conflicts with a policy-resolver in case multiple policies are found applicable in a particular evaluation.

5. An apparatus for defining, disseminating, and evaluating policies in a policy-based decision system, said apparatus comprising:
means for defining a hierarchy of policy groups;
means for associating a group of orthogonal parameters with at least one of said policy groups;
means for defining a policy for one of said policy groups;
means for disseminating said one policy group to a decision making component;
means for evaluating said policy for said one of said policy groups; and
means for associating a group of orthogonal parameters with a policy group,
wherein said group of orthogonal parameters comprises:
input variables to be resolved at a policy evaluation time;
action descriptions for applicable polices at the policy evaluation time; and
action parameters to be resolved at the policy evaluation time, and
wherein said means for defining said policy comprises:
means for aggregating the orthogonal parameters associated
with said policy group and one other policy group;
means for exposing said aggregated orthogonal parameters to a policy author, and where policy updates for a particular policy group include relevant policy updates in ancestral policy groups, and
means for resolving conflicts that give priorities to first the policies defined higher or lower in the policy group hierarchy; and
second the policies with higher assigned priority,
wherein said means for defining a hierarchy of policy groups produces a multiple inheritance data structure to relate at least two policy groups in parent child relationships,
wherein said means for disseminating policies includes a mechanism that allows a decision making component to register for policies in at least one policy group and receive policy updates relevant only to the registered policy groups, and
wherein said apparatus further comprises means for resolving conflicts with a policy-resolver in case multiple policies are found applicable in a particular evaluation.
